(19) United States
(12) Patent Application Publication
(10) Pub. No.: US 2025/0076336 A1
(43) Pub. Date: Mar. 6, 2025

(54) Sensor Device

(71) Applicant: SEIKO EPSON CORPORATION, Tokyo (JP)

(72) Inventor: Tomoaki TAKAHASHI, Minowa (JP)

(21) Appl. No.: 18/815,911

(22) Filed: Aug. 27, 2024

(30) Foreign Application Priority Data
Aug. 28, 2023 (JP) 2023-137858

(51) Int. Cl. G01P 3/44; G01C 21/16; G01P 21/02

(52) U.S. Cl. CPC G01P 3/44; G01P 21/02; G01C 21/16

(57) ABSTRACT

A sensor device includes, when it is assumed that three axes that are orthogonal to each other are a first axis, a second axis, and a third axis, a first axis angular speed sensor that detects an angular speed around the first axis and outputs a first angular speed signal, a second axis angular speed sensor that detects an angular speed around the second axis and outputs a second angular speed signal, a third axis angular speed sensor that detects an angular speed around the third axis and outputs a third angular speed signal, a fourth axis angular speed sensor that detects an angular speed around a fourth axis that corresponds to the third axis and outputs a fourth angular speed signal, and a correction circuit that estimates a correction coefficient used for correcting an error of the fourth angular speed signal due to a shift of the fourth axis with respect to the third axis, based on the first angular speed signal, the second angular speed signal, the third angular speed signal, and the fourth angular speed signal.

The present application is based on, and claims priority from JP Application Serial Number 2023-137858, filed Aug. 28, 2023, the disclosure of which is hereby incorporated by reference herein in its entirety.

### BACKGROUND

### 1. Technical Field

The present disclosure relates to a sensor device.

### 2. Related Art

In JP-A-2019-158425, an inertial measurement device including an inertial sensor including a three-axis angular speed sensor and a highly accurate Z-axis angular speed sensor is described.

As in the inertial measurement device escribed in JP-A-2019-158425, when a highly accurate Z-axis angular speed sensor is provided as a separate body from an inertial sensor including a three-axis angular speed sensor, misalignment can occur between the three-axis angular speed sensor and the Z-axis angular speed sensor. There is a probability that this misalignment causes an error in an angular speed signal that is output from the Z-axis angular speed sensor.

### SUMMARY

According to an aspect of the present disclosure, a sensor device includes, when it is assumed that three axes that are orthogonal to each other are a first axis, a second axis, and a third axis, a first axis angular speed sensor that detects an angular speed around the first axis and outputs a first angular speed signal, a second axis angular speed sensor that detects an angular speed around the second axis and outputs a second angular speed signal, a third axis angular speed sensor that detects an angular speed around the third axis and outputs a third angular speed signal, a fourth axis angular speed sensor that detects an angular speed around a fourth axis that corresponds to the third axis and outputs a fourth angular speed signal, and a correction circuit that estimates a correction coefficient used for correcting an error of the fourth angular speed signal due to a shift of the fourth axis with respect to the third axis, based on the first angular speed signal, the second angular speed signal, the third angular speed signal, and the fourth angular speed signal.

### BRIEF DESCRIPTION OF THE DRAWINGS

FIG. 1 is a cross-sectional view illustrating a structure of a major portion of a sensor device of an embodiment.

FIG. 2 is an explanatory illustration of an X-axis, a Y-axis, and a Z-axis.

FIG. 3 is a diagram illustrating a configuration of a sensor system.

FIG. 4 is a diagram illustrating a configuration example of an angular speed sensor.

FIG. 5 is a diagram illustrating a configuration example of an inertial sensor.

FIG. 6 is a diagram illustrating a configuration example of a processing device.

FIG. 7 is a diagram illustrating a flow of processing of a correction circuit using a Kalman filter.

FIG. 8 is a chart illustrating an example of time series data of ωₓ, ₖ, ω_{y}, ₖ, ω_{z}, ₖ, and Ω_{z}, ₖ.

FIG. 9 is a chart illustrating time series data of alignment correction coefficients c₁, ₖ, c₂, ₖ, and c₃, ₖ.

FIG. 10 is a chart illustrating time series data of a deviation of a Z-axis angular speed before and after correction processing.

### DESCRIPTION OF EMBODIMENTS

A preferred embodiment of the present disclosure will be described in detail below with reference to the accompanying drawings. Note that the embodiment described below does not unjustly limit the contents of the present disclosure described in the appended claims. In addition, not all configurations described below are necessarily essential components of the present disclosure.

### 1. Embodiment

### 1-1. Structure of Sensor Device

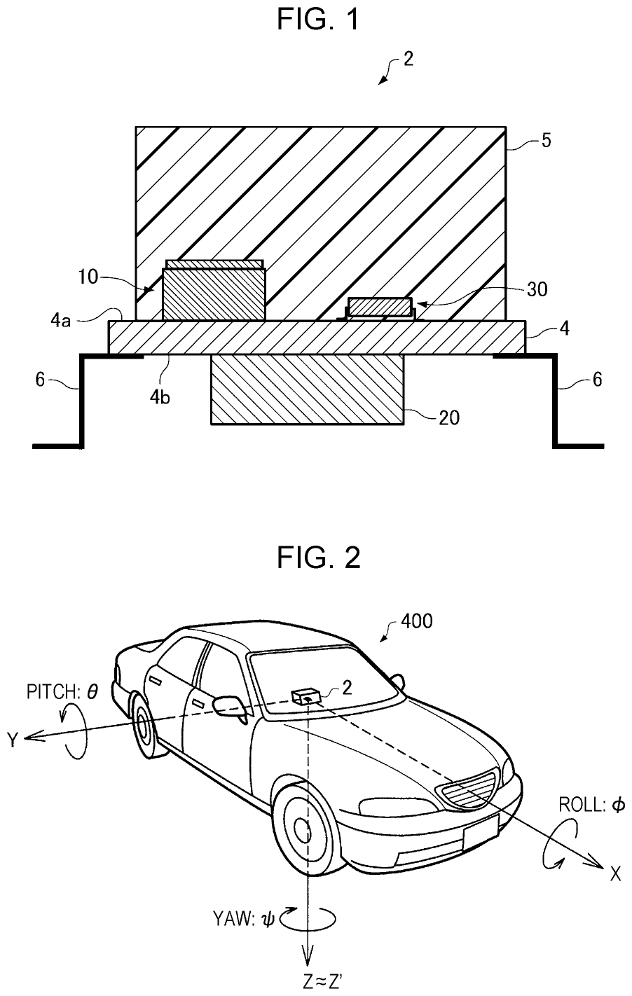

First, a structure of a sensor device according to an embodiment will be described. FIG. 1 is a cross-sectional view illustrating a structure of a major portion of a sensor device 2 of this embodiment. As illustrated in FIG. 1, the sensor device 2 includes an angular speed sensor 10, an inertial sensor 20, and a processing device 30. As illustrated in FIG. 1, the sensor device 2 includes a mounting substrate 4 on which the angular speed sensor 10, the inertial sensor 20, and the processing device 30 are mounted.

The mounting substrate 4 is, for example, a multilayer substrate in which a plurality of through holes are formed and a glass epoxy substrate is used. However, the mounting substrate 4 is not limited to the glass epoxy substrate, any rigid substrate on which the angular speed sensor 10, the inertial sensor 20, and the processing device 30 can be mounted may be used, and, for example, a composite substrate or a ceramic substrate may be used.

The angular speed sensor 10 and the processing device 30 are mounted on a first surface 4a of the mounting substrate 4 and are fixed by an approximately rectangular parallelepiped shaped mold resin 5. Because of the mold resin 5, the angular speed sensor 10 and the processing device 30 are less likely to be affected by impact, temperature, humidity, or the like. The inertial sensor 20 is mounted on a second surface 4b of the mounting substrate 4 that is in a front and back relationship with the first surface 4a. As described above, the angular speed sensor 10 is mounted on the first surface 4a of the mounting substrate 4 and the inertial sensor 20 is mounted on the second surface 4b of the mounting substrate 4, and thus, a size of the mounting substrate 4 can be reduced, so that area saving can be realized. Each of the angular speed sensor 10 and the inertial sensor 20 is electrically coupled to the processing device 30 via an unillustrated wiring provided on the mounting substrate 4. Note that a plurality of other electronic components, such as, for example, a temperature sensor or the like, may be mounted on the mounting substrate 4.

A plurality of external connection terminals 6 extend on the second surface 4b of the mounting substrate 4. The external connection terminals 6 are electrically coupled to a function terminal of the processing device 30 and respective power supply terminals and respective ground terminals of the angular speed sensor 10, the inertial sensor 20, and the processing device 30 via unillustrated wirings provided on the mounting substrate 4.

The sensor device 2 is configured such that a structure formed of the angular speed sensor 10, the inertial sensor 20, the processing device 30, the mounting substrate 4, the mold resin 5, and a plurality of leads and an unillustrated mounting substrate on which the structure is mounted are housed in an unillustrated case.

When it is assumed that three axes that are orthogonal to each other are a first axis, a second axis, and a third axis, the inertial sensor 20 detects an angular speed around the first axis, an angular speed around the second axis, and an angular speed around the third axis. In this embodiment, the inertial sensor 20 further detects an acceleration in a first axis direction, an acceleration in a second axis direction, and an acceleration in a third axis direction. That is, in this embodiment, the inertial sensor 20 is a 6DOF sensor that detects angular speeds around three axes and accelerations in three axis directions. DOF is an abbreviation for Degree Of Freedom. For example, the inertial sensor 20 is an electrostatic capacity-type sensor obtained by processing a silicon substrate using a MEMS technology. MEMS is an abbreviation for Micro Electro Mechanical Systems.

The angular speed sensor 10 detects an angular speed around a fourth axis that corresponds to the third axis. For example, the angular speed sensor 10 is a vibration gyro sensor that includes a sensor element formed of crystal as a material and detects an angular speed from a Coriolis force applied to a vibrating object. In this embodiment, accuracy of detection of the angular speed around the fourth axis by the angular speed sensor 10 is higher than accuracy of detection of the angular speed around the third axis by the inertial sensor 20.

Description will be hereinafter made assuming that the first axis is an X-axis, the second axis is a Y-axis, the third axis is a Z-axis, and the fourth axis is a Z′-axis.

The angular speed sensor 10 and the inertial sensor 20 are housed in a single case such that the Z′-axis and the Z-axis extend in the same direction to form the sensor device 2 that detects the angular speeds around the three axes and the accelerations in the three axis directions. Ideally, the Z′-axis matches the Z-axis, but in reality, since the angular speed sensor 10 and the inertial sensor 20 are separates bodies, there is a probability that the Z′-axis and the Z-axis are slightly shifted from each other. The processing device 30 estimates this shift between the Z′-axis and the Z-axis, and thus, corrects an angular speed around the Z′-axis that is detected by the angular speed sensor 10. The processing device 30 is, for example, MCU and is configured as a single chip IC. MCU is an abbreviation for Micro Controller Unit, and IC is an abbreviation for Integrated Circuit.

The sensor device 2 is fixed to a target attachment surface of a target attachment body, such as, for example, an automobile, a robot, or the like and detects a behavior of the target attachment body. Note that the target attachment body is not limited to a moving body, such as an automobile or the like, and may be a building, such as, for example, a bridge, an elevated track, or the like. When the sensor device 2 is attached to a building, the sensor device 2 is used, for example, as a structure health monitoring system used for checking soundness of the building.

As illustrated in FIG. 2, when the sensor device 2 is mounted on an automobile 400, for example, the sensor device 2 is attached thereto such that the X-axis extends in a traveling direction of the automobile 400, the Y-axis extends in a rightward direction that is orthogonal to the traveling direction, and a Z-axis direction extends in a downward direction that is orthogonal to the traveling direction. The angular speed sensor 10 detects the angular speed around the Z′-axis that corresponds to the Z-axis, and the inertial sensor 20 detects the angular speed around the X-axis, the angular speed around the Y-axis, the angular speed around the Z-axis, the acceleration in the X-axis direction, the acceleration in the Y-axis direction, and the acceleration in the Z-axis direction. The sensor device 2 may be configured to output data including the angular speed around the Z-axis obtained by correcting the angular speed around the Z′-axis detected by the angular speed sensor 10 and the angular speeds around the three axes and the accelerations in the three axis directions detected by the inertial sensor 20. Alternatively, for example, the sensor device 2 may be configured to output data including the angular speed around the Z-axis obtained by correcting the angular speed around the Z′-axis detected by the angular speed sensor 10 and the angular speed around the X-axis, the angular speed around the Y-axis, and the accelerations in the three axis directions detected by the inertial sensor 20.

As illustrated in FIG. 2, the sensor device 2 may be configured to output data including a roll angle σ, a pitch angle θ, and a yaw angle ψ that indicate an attitude of the automobile 400. The roll angle σ is a rotation angle with the X-axis extending in the traveling direction of the automobile 400 as a rotation axis. The pitch angle θ is a rotation angle with the Y-axis extending in the rightward direction that is orthogonal to the traveling direction of the automobile 400 as a rotation axis. The yaw angle ψ is a rotation angle with the Z-axis extending in the downward direction that is orthogonal to the traveling direction of the automobile 400 as a rotation axis.

### 1-2. Configuration of Sensor System

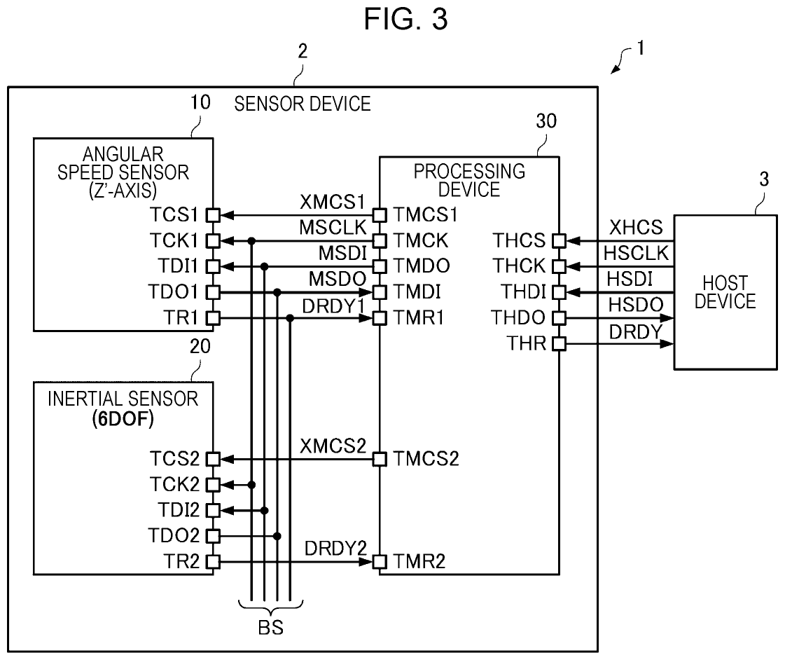

Next, a configuration and a function of a sensor system 1 using the sensor device 2 will be described. A functional configuration of the sensor device 2 will be described as well. FIG. 3 is a diagram illustrating a configuration of the sensor system 1. As illustrated in FIG. 3, the sensor system 1 includes the sensor device 2 and a host device 3.

The sensor device 2 includes the angular speed sensor 10, the inertial sensor 20, and the processing device 30. Note that the sensor device 2 may have a configuration obtained by omitting or changing some of components in FIG. 3 or adding some other component.

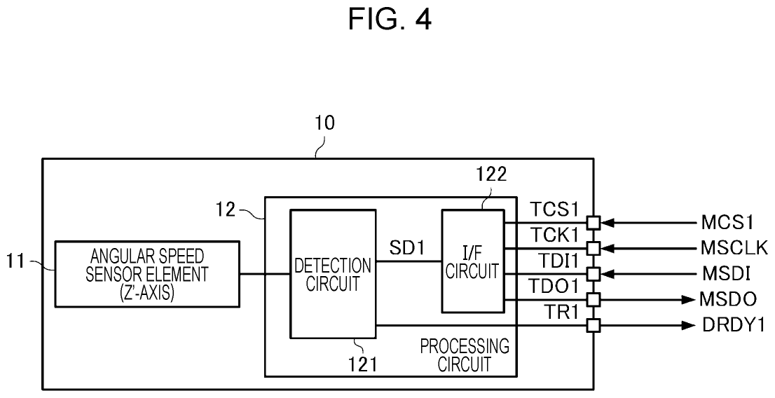

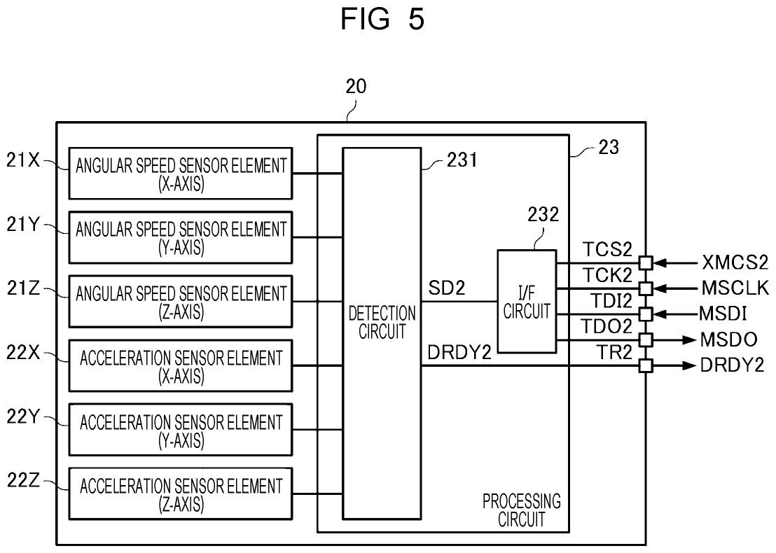

As described above, the angular speed sensor 10 is an angular speed sensor that detects the angular speed around the Z′-axis. FIG. 4 is a diagram illustrating a configuration example of the angular speed sensor 10.

As illustrated in FIG. 4, the angular speed sensor 10 includes an angular speed sensor element 11 and a processing circuit 12. For example, the angular speed sensor 10 may be a device in which a print substrate on which the angular speed sensor element 11 and the processing circuit 12 are mounted is housed in a package. The processing circuit 12 may be, for example, an IC chip realized by a semiconductor. The angular speed sensor 10 includes a terminal TCS1, a terminal TCK1, a terminal TDI1, a terminal TDO1, and a terminal TR1 that are terminals used for external connection provided in the package.

The angular speed sensor element 11 is a sensor element formed of crystal as a material and detects the angular speed around the Z′-axis with the Z′-axis serving as a detection axis.

The processing circuit 12 performs angular speed detection processing on a signal that is output from the angular speed sensor element 11 and outputs a detection signal SD1 obtained by detection processing. The processing circuit 12 includes a detection circuit 121 that performs angular speed detection processing on a signal that is output from the angular speed sensor element 11 and an interface circuit 122 that outputs the detection signal SD1 obtained by detection processing of the detection circuit 121.

The detection circuit 121 acquires a signal that is output from the angular speed sensor element 11 in a predetermined cycle and performs a predetermined arithmetic operation to generate the detection signal SD1. The detection signal SD1 includes a Z′-axis angular speed detection signal SD1GZ′ obtained based on an output signal of the angular speed sensor element 11. The detection circuit 121 generates a data ready signal DRDY1 that informs completion of preparation of the detection signal SD1 each time generation of the detection signal SD1 is completed. The detection signal SD1 is output to the interface circuit 122, the data ready signal DRDY1 is output from the terminal TR1 and is input to a terminal TMR1 of the processing device 30.

In accordance with a read command that is input from the processing device 30, the interface circuit 122 acquires the detection signal SD1 that is output from the detection circuit 121 and outputs the acquired detection signal SD1 to the processing device 30.

Returning to description of FIG. 3, as described above, the inertial sensor 20 is a 6DOF sensor that detects the angular speeds around the three axes, that is, the X-axis, the Y-axis, and the Z-axis, and the accelerations in the three axis directions, that is, the X-axis, Y-axis, and Z-axis directions. FIG. 5 is a diagram illustrating a configuration example of the inertial sensor 20. As illustrated in FIG. 5, the inertial sensor 20 includes angular speed sensor elements 21X, 21Y, and 21Z, acceleration sensor elements 22X, 22Y, and 22Z, and a processing circuit 23. For example, the inertial sensor 20 may be a silicon MEMS sensor in which a silicon substrate on which the angular speed sensor elements 21X, 21Y, and 21Z, the acceleration sensor elements 22X, 22Y, and 22Z, and the processing circuit 23 are formed is housed in a package. The inertial sensor 20 includes a terminal TCS2, a terminal TCK2, a terminal TDI2, a terminal TDO2, and a terminal TR2 that are terminals used for external connection provided in the package.

The angular speed sensor element 21X is a sensor element that detects the angular speed around the X-axis with the X-axis serving as a detection axis. The angular speed sensor element 21Y is a sensor element that detects the angular speed around the Y-axis with the Y-axis serving as a detection axis. The angular speed sensor element 21Z is a sensor element that detects the angular speed around the Z-axis with the Z-axis serving as a detection axis.

The acceleration sensor element 22X is a sensor element that detects the acceleration in the X-axis direction with the X-axis serving as a detection axis. The acceleration sensor element 22Y is a sensor element that detects the acceleration in the Y-axis direction with the Y-axis serving as a detection axis. The acceleration sensor element 22Z is a sensor element that detects the acceleration in the Z-axis direction with the Z-axis serving as a detection axis.

The processing circuit 23 performs angular speed detection processing on respective signals that are output from the angular speed sensor elements 21X, 21Y, and 21Z, performs acceleration detection processing on respective signals that are output from the acceleration sensor elements 22X, 22Y, and 22Z, and outputs a detection signal SD2 obtained by detection processing. The processing circuit 23 includes a detection circuit 231 that performs detection processing on respective signals that are output from the angular speed sensor elements 21X, 21Y, and 21Z and the acceleration sensor elements 22X, 22Y, and 22Z and an interface circuit 232 that outputs the detection signal SD2 obtained by detection processing of the detection circuit 231.

The detection circuit 231 acquires respective signals that are output from the angular speed sensor elements 21X, 21Y, and 21Z and the acceleration sensor elements 22X, 22Y, and 22Z in a predetermined cycle and performs a predetermined arithmetic operation to generate the detection signal SD2. The detection signal SD2 includes an X-axis angular speed detection signal SD2GX obtained based on an output signal of the angular speed sensor element 21X, a Y-axis angular speed detection signal SD2GY obtained based on an output signal of the angular speed sensor element 21Y, and a Z-axis angular speed detection signal SD2GZ obtained based an output signal of the angular speed sensor element 21Z. Furthermore, the detection signal SD2 includes an X-axis acceleration detection signal SD2AX obtained based on an output signal of the acceleration sensor element 22X, a Y-axis acceleration detection signal SD2AY obtained based on an output signal of the acceleration sensor element 22Y, and a Z-axis acceleration detection signal SD2AZ obtained based on an output signal of the acceleration sensor element 22Z. The detection circuit 231 generates a data ready signal DRDY2 that informs completion of preparation of the detection signal SD2 each time generation of the detection signal SD2 is completed. The detection signal SD2 is output to the interface circuit 232 and the data ready signal DRDY2 is output from the terminal TR2 and is input to a terminal TMR2 of the processing device 30.

In accordance with a read command that is input from the processing device 30, the interface circuit 232 acquires the detection signal SD2 that is output from the detection circuit 231 and outputs the acquired detection signal SD2 to the processing device 30.

Returning to description of FIG. 3, the sensor device 2 includes a digital interface bus BS that electrically couples the angular speed sensor 10, the inertial sensor 20, and the processing device 30.

The digital interface bus BS is a bus compliant with a communication standard of interface processing performed by the interface circuits 122 and 232. In this embodiment, the digital interface bus BS is a bus compliant with a communication standard of SPI and incudes two data signal lines, a clock signal line, and a chip select signal line. SPI is an abbreviation for Serial Peripheral Interface. Specifically, the angular speed sensor 10 is electrically coupled to the digital interface bus BS via the terminal TCS1, the terminal TCK1, the terminal TDI1, and the terminal TDO1. The inertial sensor 20 is electrically coupled to the digital interface bus BS via the terminal TCS2, the terminal TCK2, the terminal TDI2, and the terminal TDO2. The processing device 30 is electrically coupled to the digital interface bus BS via a terminal TMCS1, a terminal TMCS2, a terminal TMCK, a terminal TMDO, and a terminal TMDI. Herein, being electrically coupled refers to being coupled such that an electrical signal can be transmitted, and refers to connection that enables transmission of information by an electrical signal. However, the digital interface bus BS may be a bus compliant with a communication standard of I2C, a communication standard obtained by developing SPI or I2C, a communication standard obtained by improving or changing a part of the standard of SPI or I2C, or the like. I2C is an abbreviation for Inter-Integrated Circuit.

The processing device 30 is a controller that serves as a master with respect to the angular speed sensor 10 and the inertial sensor 20. The processing device 30 is an integrated circuit device and is realized by a processor, such as, for example, MCU or the like. Alternatively, the processing device 30 may be realized by ASIC using automatic placement and routing, such as a gate array or the like.

The processing device 30 outputs a chip select signal XMCS1 from the terminal TMCS1, outputs a chip select signal XMCS2 from the terminal TMCS2, outputs a serial clock signal MSCLK from the terminal TMCK, and outputs a serial data signal MSDI from the terminal TMDO.

The interface circuit 122 performs interface processing in accordance with the communication standard of SPI, based on the chip select signal XMCS1 that is input from the terminal TCS1, the serial clock signal MSCLK that is input from the terminal TCK1, and the serial data signal MSDI that is input from the terminal TDI1, and when the serial data signal MSDI is a read command of the detection signal SD1, outputs the detection signal SD1 to the terminal TDO1.

The interface circuit 232 performs interface processing in accordance with the communication standard of SPI, based on the chip select signal XMCS2 that is input from the terminal TCS2, the serial clock signal MSCLK that is input from the terminal TCK2, and the serial data signal MSDI that is input from the terminal TDI2, and when the serial data signal MSDI is a read command of the detection signal SD2, outputs the detection signal SD2 to the terminal TDO2.

Each of the detection signal SD1 output from the terminal TDO1 of the angular speed sensor 10 and the detection signal SD2 output from the terminal TDO2 of the inertial sensor 20 is input, as the serial data signal MSDO, to the terminal TMDI of the processing device 30.

The detection signal SD1 that is output from the angular speed sensor 10 and the detection signal SD2 that is output from the inertial sensor 20 are input to the processing device 30 and the processing device 30 outputs measurement data based on the detection signals SD1 and SD2. Specifically, when the data ready signal DRDY1 is input to the processing device 30 from the terminal TMR1, the processing device 30 outputs a read command of the detection signal SD1 to the angular speed sensor 10 to read the detection signal SD1 and performs various types of arithmetic operation processing on the detection signal SD1, and when the data ready signal DRDY2 is input to the processing device 30 from the terminal TMR2, the processing device 30 outputs a read command of the detection signal SD2 to the inertial sensor 20 to read the detection signal SD2 and performs various types of arithmetic operation processing on the detection signal SD2.

For example, the processing device 30 may be configured to perform a temperature correction arithmetic operation, a sensitivity correction arithmetic operation, an offset correction arithmetic operation, an alignment correction arithmetic operation, or the like on the detection signals SD1 and SD2. The temperature correction arithmetic operation is an arithmetic operation by which correction is performed in a preset temperature range to reduce temperature dependence of the detection signals SD1 and SD2 by increasing or reducing the detection signals SD1 and SD2 in accordance with a temperature detected by an unillustrated temperature sensor. The sensitivity correction arithmetic operation is an arithmetic operation by which correction is performed such that a detection sensitivity of each axis is a reference value. The offset correction arithmetic operation is an arithmetic operation by which correction is performed such that a zero point of each axis is a reference value. The alignment correction arithmetic operation is an arithmetic operation by which an error due to a shift of a detection axis of each sensor element from the X-axis, the Y-axis, and the Z-axis of the sensor device 2 is corrected.

The processing device 30 may be configured to perform an arithmetic operation that calculates an attitude, a speed, an angle, or the like of the sensor device 2, based on the detection signals SD1 and SD2.

Note that the processing device 30 may be configured to perform a down sampling arithmetic operation by which, when a cycle in which a series of arithmetic operations is performed is longer than each of respective cycles of the data ready signals DRDY1 and DRDY2, a portion of each of the detection signals SD1 and SD2 is thinned out.

In this embodiment, the processing device 30 is electrically coupled to the host device 3 via a terminal THCS, a terminal THCK, a terminal THDI, a terminal THDO, and a terminal THR. The host device 3 is a controller that serves as a master with respect to the processing device 30. The processing device 30 outputs a data ready signal DRDY that informs completion of preparation of measurement data from the terminal THR to the host device 3 each time a series of arithmetic operations for the detection signals SD1 and SD2 is completed. The host device 3 outputs a chip select signal XHCS and a serial clock signal HSCLK that are compliant with the communication standard of SPI and a serial data signal HSDI that is a read command of the measurement data to the processing device 30 each time the data ready signal DRDY is input thereto from the terminal THR. The processing device 30 performs interface processing in accordance with of the communication standard of SPI, based on the chip select signal XHCS that is input from the terminal THCS, the serial clock signal HSCLK that is input from the terminal THCK, and the serial data signal HSDI that is input from the terminal THDI, to output the measurement data to the terminal THDO. The measurement data output from the terminal THDO of the processing device 30 is input, as a serial data signal HSDO, to the host device 3. However, the processing device 30 may be configured to perform interface processing in accordance with the communication standard of I2C, a communication standard obtained by developing SPI or I2C, a communication standard obtained by improving or changing a part of SPI or I2C, or the like.

As described above, the acceleration sensor element 22X of the inertial sensor 20 detects the acceleration in the X-axis direction. Therefore, the processing device 30 generates X-axis acceleration measurement data A_{X}, based on the X-axis acceleration detection signal SD2AX included in the detection signal SD2, and when the processing device 30 receives a read command of the X-axis acceleration measurement data A_{X} from the host device 3, outputs the generated X-axis acceleration measurement data A_{X}. Similarly, the acceleration sensor element 22Y of the inertial sensor 20 detects the acceleration in the Y-axis direction. Therefore, the processing device 30 generates Y-axis acceleration measurement data A_{Y}, based on the Y-axis acceleration detection signal SD2AY included in the detection signal SD2, and when the processing device 30 receives a read command of the Y-axis acceleration measurement data A_{Y} from the host device 3, outputs the generated Y-axis acceleration measurement data A_{Y}. Similarly, the acceleration sensor element 22Z of the inertial sensor 20 detects the acceleration in the Z-axis direction. Therefore, the processing device 30 generates Z-axis acceleration measurement data A_{Z}, based on the Z-axis acceleration detection signal SD2AZ included in the detection signal SD2, and when the processing device 30 receives a read command of the Z-axis acceleration measurement data A_{Z} from the host device 3, outputs the generated Z-axis acceleration measurement data A_{Z}.

As described above, the angular speed sensor element 21X of the inertial sensor 20 detects the angular speed around the X-axis. Therefore, the processing device 30 generates X-axis angular speed measurement data G_{X}, based on the X-axis angular speed detection signal SD2GX included in the detection signal SD2, and when the processing device 30 receives a read command of the X-axis angular speed measurement data G_{X} from the host device 3, outputs the generated X-axis angular speed measurement data G_{X}. Similarly, the angular speed sensor element 21Y of the inertial sensor 20 detects the angular speed around the Y-axis. Therefore, the processing device 30 generates Y-axis angular speed measurement data G_{Y}, based on the Y-axis angular speed detection signal SD2GY included in the detection signal SD2, and when the processing device 30 receives a read command of the Y-axis angular speed measurement data G_{Y} from the host device 3, outputs the generated Y-axis angular speed measurement data G_{Y}. On the other hand, the angular speed sensor element 21Z of the inertial sensor 20 detects the angular speed around the Z-axis and the angular speed sensor element 11 of the angular speed sensor 10 detects the angular speed around the Z′-axis that corresponds to the Z-axis. In this embodiment, the angular speed sensor element 21Z is an element formed of a silicon substrate using the MEMS technology, whereas the angular speed sensor element 11 is an element formed of a crystal as a material. Accordingly, as compared to the inertial sensor 20 including the angular speed sensor element 21Z, in the angular speed sensor 10 including the angular speed sensor element 11, a frequency temperature characteristic and a frequency stability are high while noise and jitter are low, and therefore, detection accuracy is high. Therefore, the processing device 30 generates Z-axis angular speed measurement data G_{Z}, based on a Z′-axis angular speed detection signal SI1GZ′ included in the detection signal SD1, and when the processing device 30 receives a read command of the Z-axis angular speed measurement data G_{Z} from the host device 3, outputs the generated Z-axis angular speed measurement data G_{Z}. As will be described later, in this embodiment, the processing device 30 generates a Z-axis angular speed detection signal SD1GZ obtained by correcting an error of the Z′-axis angular speed detection signal SD1GZ′ due to a shift of the Z′-axis with respect to the Z-axis and generates the Z-axis angular speed measurement data G_{Z}, based on the Z-axis angular speed detection signal SD1GZ.

Note that the host device 3 may be configured to transmit a read command of measurement data including the X-axis angular speed measurement data G_{X}, the Y-axis angular speed measurement data G_{Y}, the Z-axis angular speed measurement data G_{Z}, the X-axis acceleration measurement data A_{X}, the Y-axis acceleration measurement data A_{Y}, and the Z-axis acceleration measurement data A_{Z}. When the processing device 30 receives the command, the processing device 30 transmits the X-axis angular speed measurement data G_{X}, the Y-axis angular speed measurement data G_{Y}, the Z-axis angular speed measurement data G_{Z}, the X-axis acceleration measurement data A_{X}, the Y-axis acceleration measurement data A_{Y}, and the Z-axis acceleration measurement data A_{Z}.

### 1-3. Configuration of Processing Device

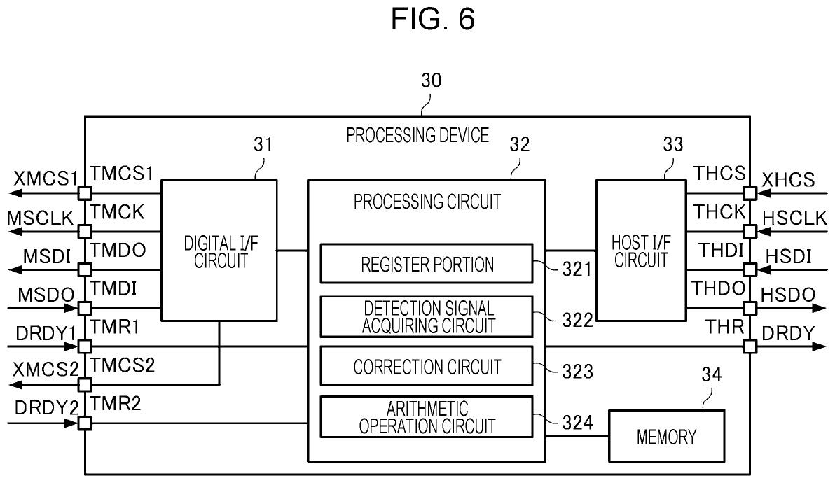

Next, a specific configuration of the processing device 30 will be described. FIG. 6 is a diagram illustrating a configuration example of the processing device 30. As illustrated in FIG. 6, the processing device 30 includes a digital interface circuit 31, a processing circuit 32, a host interface circuit 33, and a memory 34.

The digital interface circuit 31 is a circuit that performs interface processing with the angular speed sensor 10 and the inertial sensor 20. That is, the digital interface circuit 31 performs, as a master, interface processing between the interface circuit 122 and the interface circuit 232. The digital interface circuit 31 is coupled to the digital interface bus BS via the terminal TMCS1, the terminal TMCS2, the terminal TMCK, the terminal TMDO, and the terminal TMDI. In this embodiment, similar to the interface circuits 122 and 232, the digital interface circuit 31 performs interface processing in accordance with the communication standard of SPI. However, the digital interface circuit 31 may be configured to perform interface processing in accordance with the communication standard of I2C, a communication standard obtained by developing SPI or I2C, a communication standard obtained by improving or changing a part of the standard of SPI or I2C, or the like. Each of the digital interface bus BS and the digital interface circuit 31 may be provided in common for the angular speed sensor 10 and the inertial sensor 20, and may be provided separately for each of the angular speed sensor 10 and the inertial sensor 20.

The host interface circuit 33 is a circuit that performs interface processing with the host device 3. That is, the host interface circuit 33 performs, as a slave, interface processing with the host device 3. The host interface circuit 33 performs interface processing in accordance with the communication standard of SPI on the host device 3 via the terminal THCS, the terminal THCK, the terminal THDO, and the terminal THDI. However, the host interface circuit 33 may be configured to perform interface processing in accordance with the communication standard of I2C, a communication standard obtained by developing SPI or I2C, a communication standard obtained by improving or changing a part of the standard of SPI or I2C, or the like.

The processing circuit 32 performs control processing for the digital interface circuit 31 and the host interface circuit 33, various arithmetic operations, or the like. The processing circuit 32 includes a register portion 321, a detection signal acquiring circuit 322, a correction circuit 323, and an arithmetic operation circuit 324. The processing circuit 32 may be configured to perform the control processing and the arithmetic operation processing by executing an unillustrated program stored in a nonvolatile memory 34.

The register portion 321 includes various registers.

The detection signal acquiring circuit 322 outputs a read command of the detection signal SD1 to the angular speed sensor 10 via the digital interface circuit 31 and acquires the detection signal SD1 that is output from the angular speed sensor 10 via the digital interface circuit 31 each time the data ready signal DRDY1 is input thereto from the terminal TMR1. The detection signal acquiring circuit 322 outputs a read command of the detection signal SD2 to the inertial sensor 20 via the digital interface circuit 31 and acquires the detection signal SD2 that is output from the inertial sensor 20 via the digital interface circuit 31 each time the data ready signal DRDY2 is input thereto from the terminal TMR2.

As described above, the inertial sensor 20 detects the angular speed around the X-axis and functions as an X-axis angular speed sensor that outputs the X-axis angular speed detection signal SD2GX. The inertial sensor 20 detects the angular speed around the Y-axis and functions as a Y-axis angular speed sensor that outputs the Y-axis angular speed detection signal SD2GY. Furthermore, the inertial sensor 20 detects the angular speed around the Z-axis and functions as a Z-axis angular speed sensor that outputs the Z-axis angular speed detection signal SD2GZ. The X-axis angular speed sensor, the Y-axis angular speed sensor, and the Z-axis angular speed sensor are mounted integrally as the inertial sensor 20 on the first surface 4a of the mounting substrate 4. Therefore, in a manufacturing stage of the inertial sensor 20, the X-axis, the Y-axis, and the Z-axis are adjusted so as to be orthogonal to each other. In contrast, the angular speed sensor 10 is mounted as a separate body from the inertial sensor 20 that functions as the X-axis angular speed sensor, the Y-axis angular speed sensor, and the Z-axis angular speed sensor on the second surface 4b of the mounting substrate 4, and therefore, the Z′-axis and the Z-axis are likely to be shifted from each other. When the Z′-axis is shifted from the Z-axis, the Z′-axis is not orthogonal to the X-axis and the Y-axis, so that not only the angular speed sensor 10 cannot accurately detect the angular speed around the Z-axis but also the angular speed sensor 10 undesirably detects the angular speed around the X-axis and the angular speed around the Y-axis too.

Thus, the correction circuit 323 estimates an alignment correction coefficient, based on the X-axis angular speed detection signal SD2GX, the Y-axis angular speed detection signal SD2GY, and the Z-axis angular speed detection signal SD2GZ included in the detection signal SD2 acquired by the detection signal acquiring circuit 322 and the Z′-axis angular speed detection signal SD1GZ′ included in the detection signal SD1 acquired by the detection signal acquiring circuit 322. The alignment correction coefficient is a correction coefficient with which an error of the Z′-axis angular speed detection signal SDIGZ′ due to a shift of the Z′-axis with respect to the Z-axis. Then, the correction circuit 323 generates the Z-axis angular speed detection signal SD1GZ obtained by correcting the error of the Z′-axis angular speed detection signal SD1GZ′, based on the estimated alignment correction coefficient. Details of processing of the correction circuit 323 will be described later.

The arithmetic operation circuit 324 executes various arithmetic operations on the detection signal SD2 acquired by the detection signal acquiring circuit 322 and the Z-axis angular speed detection signal SD1GZ generated by the correction circuit 323. For example, the arithmetic operation circuit 324 performs a temperature correction arithmetic operation on the X-axis angular speed detection signal SD2GX, the Y-axis angular speed detection signal SD2GY, the X-axis acceleration detection signal SD2AX, the Y-axis acceleration detection signal SD2AY, and the Z-axis acceleration detection signal SD2AZ included in the detection signal SD2 and the Z-axis angular speed detection signal SD1GZ, based on a temperature signal that is output from an unillustrated temperature sensor. The arithmetic operation circuit 324 performs a sensitivity correction arithmetic operation, an offset correction arithmetic operation, an alignment correction arithmetic operation, or the like on the X-axis angular speed detection signal SD2GX, the Y-axis angular speed detection signal SD2GY, the Z-axis angular speed detection signal SD1GZ, the X-axis acceleration detection signal SD2AX, the Y-axis acceleration detection signal SD2AY, and the Z-axis acceleration detection signal SD2AZ. Note that the arithmetic operation circuit 324 may be configured not to perform some of the temperature correction arithmetic operation, the sensitivity correction arithmetic operation, the offset correction arithmetic operation, and the alignment correction arithmetic operation, and may be configured to perform some other correction arithmetic operation.

The arithmetic operation circuit 324 generates the X-axis angular speed measurement data G_{X} based on the X-axis angular speed detection signal SD2GX, the Y-axis angular speed measurement data G_{Y} based on the Y-axis angular speed detection signal SD2GY, the Z-axis angular speed measurement data G_{Z} based on the Z-axis angular speed detection signal SD1GZ, the X-axis acceleration measurement data A_{X} based on the X-axis acceleration detection signal SD2AX, the Y-axis acceleration measurement data A_{Y} based on the Y-axis acceleration detection signal SD2AY, and the Z-axis acceleration measurement data A_{Z} based on the Z-axis acceleration detection signal SD2AZ. The X-axis angular speed measurement data G_{X}, the Y-axis angular speed measurement data G_{Y}, the Z-axis angular speed measurement data G_{Z}, the X-axis acceleration measurement data A_{X}, the Y-axis acceleration measurement data A_{Y}, and the Z-axis acceleration measurement data A_{Z} are stored in different registers of the register portion 321.

Note that, when a cycle in which a series of arithmetic operations is performed is longer than each of respective cycles of the data ready signals DRDY1 and DRDY2, after performing the down sampling arithmetic operation by which a portion of each of the detection signals SD1 and SD2 is thinned out, the arithmetic operation circuit 324 performs various type of arithmetic operations.

When the series of arithmetic operations is completed, the arithmetic operation circuit 324 outputs the data ready signal DRDY to the host device 3 via the terminal THR. When a read command of measurement data from the host device 3 is input via the host interface circuit 33, the arithmetic operation circuit 324 outputs the measurement data requested by the command to the host device 3 via the host interface circuit 33.

The host device 3 can read the X-axis angular speed measurement data G_{X}, the Y-axis angular speed measurement data G_{Y}, the Z-axis angular speed measurement data G_{Z}, the X-axis acceleration measurement data A_{X}, the -axis acceleration measurement data A_{Y}, and the Z-axis acceleration measurement data A_{Z} by designating different addresses, and can collectively read a plurality of pieces of measurement data. The host device 3 may be configured to calculate the speed and the attitude of the sensor device 2, based on the read measurement data. Alternatively, the arithmetic operation circuit 324 may be configured to perform an arithmetic operation that calculates the attitude and the speed of the sensor device 2, based on the X-axis angular speed measurement data G_{X}, the Y-axis angular speed measurement data G_{Y}, the Z-axis angular speed measurement data G_{Z}, the X-axis acceleration measurement data A_{X}, the Y-axis acceleration measurement data A_{Y}, and the Z-axis acceleration measurement data A_{Z}. Respective pieces of measurement data of the attitude and the speed of the sensor device 2 are stored in different registers of the register portion 321. The attitude may be expressed by the roll angle σ, the pitch angle θ, and the yaw angle ψ, as described above, and may be expressed by a Eulerian angle and a quaternion.

For example, when the sensor device 2 is attached to the automobile 400, the host device 3 can perform, for example, travel assistance, automatic drive control, or the like of the automobile 400, based on the speed and the attitude of the sensor device 2, that is, a speed and an attitude of the automobile 400. In travel assistance and automatic drive control of the automobile 400, among the roll angle σ, the pitch angle θ, and the yaw angle ψ that indicate the attitude of the automobile 400, the yaw angle is most important. Therefore, it is desired that an error of the yaw angle ψ is smaller than each of respective errors of the roll angle σ and the pitch angle θ. For this reason, the sensor device 2 includes the angular speed sensor 10 that highly accurately detects the angular speed around the Z′-axis in order to calculate the yaw angle ψ with high accuracy.

In particular, the errors of the roll angle σ, the pitch angle θ, and the yaw angle ψ increase with time due to a bias error Bx [deg/sec] of the X-axis angular speed detection signal SD2GX, a bias error By [deg/sec] of the Y-axis angular speed detection signal SD2GY, and a bias error Bz′ [deg\sec] of the Z′-axis angular speed detection signal SD1GZ′. The host device 3 can calculate a direction of gravity acceleration, based on the X-axis acceleration detection signal SD2AX, the Y-axis acceleration detection signal SD2AY, and the Z-axis acceleration detection signal SD2AZ when the automobile 400 is stopped, and thus, can correct the roll angle σ and the pitch angle θ from the direction of gravity acceleration. However, when the automobile 400 travels on a substantially level road, a direction of the Z′-axis substantially matches the gravity acceleration direction, and therefore, it is very difficult for the host device 3 to correct the yaw angle ψ from the direction of gravity acceleration. Therefore, it is desired that the bias error Bz′ [deg/sec] of the Z′-axis angular speed detection signal SD1GZ′ is small. Since the sensor device 2 generates the Z-axis angular speed measurement data G_{Z} using the Z′-axis angular speed detection signal SD1GZ′, instead of the Z-axis angular speed detection signal SD2GZ, at least it is necessary that Bz′<Bz and it is preferable that Bz′<Bz<2 holds. As described above, the error of the yaw angle ψ can be reduced by making the bias error Bz′ of the Z′-axis angular speed detection signal SD1GZ′ relatively small.

### 1-4. Processing of Correction Circuit

Next, specific processing of the correction circuit 323 will be described. In this embodiment, the correction circuit 323 estimates an alignment correction coefficient by a Kalman filter arithmetic operation where the Z-axis angular speed detection signal SD2GZ is a target value of the Z′-axis angular speed detection signal SDIGZ′.

In the following description, it is assumed that the X-axis angular speed detection signal SD2GX is ωₓ, ₖ, the Y-axis angular speed detection signal SD2GY is ω_{y}, ₖ, the Z-axis angular speed detection signal SD2GZ is ω_{z}, ₖ, and the Z′-axis angular speed detection signal SDIGZ′ is Ω_{z}, ₖ. k represents time.

First, as indicated by Expression 1, an angular speed matrix Xₖ of one row and three columns using ωₓ, ₖ, ω_{y}, ₖ, and Ω_{z}, k as elements is defined.

$${X}_{k} = ( \begin{matrix}{ω}_{x , k} & {ω}_{y , k} & {Ω}_{z , k}\end{matrix} ) \qquad ( 1 )$$

As indicated by Expression 2, a correction coefficient matrix θₖ of three rows and one column using estimated alignment correction coefficients c₁, ₖ, c₂, ₖ, and c₃, ₖ as elements is defined. A correction coefficient matrix θ₀ that is an initial value of the correction coefficient matrix θₖ is defined as indicated by Expression 3.

$${Θ}_{k} = ( \begin{matrix}{c}_{1 , k} \\ {c}_{2 , k} \\ {c}_{3 , k}\end{matrix} ) \qquad ( 2 )$$

$${Θ}_{0} = ( \begin{matrix}0 \\ 0 \\ 1\end{matrix} ) \qquad ( 3 )$$

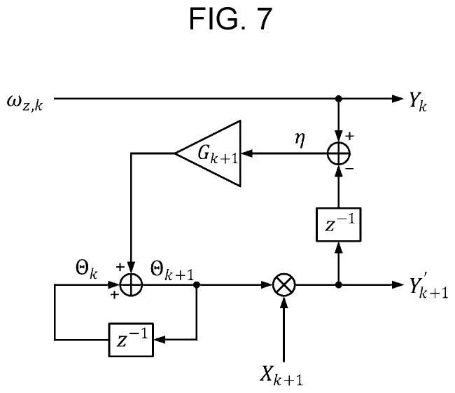

The correction circuit 323 executes a prediction step, an observation step, and an update step of a Kalman filter to estimate the correction coefficient matrix Ok. In FIG. 7, a flow of processing of the correction circuit 323 using the Kalman filter is illustrated.

First, in the prediction step, the correction circuit 323 predicts a corrected value Y′k of Ω_{z}, k at a time k from the correction coefficient matrix θₖ updated in an update step at a time k−1. The corrected value Y′k corresponds to the Z-axis angular speed detection signal SD1GZ obtained by correcting the Z′-axis angular speed detection signal SD1GZ′.

$${Y}_{k}^{′} = {X}_{k} {Θ}_{k} = ( \begin{matrix}{ω}_{x , k} & {ω}_{y , k} & {Ω}_{z , k}\end{matrix} ) ( \begin{matrix}{c}_{1 , k} \\ {c}_{2 , k} \\ {c}_{3 , k}\end{matrix} ) = {ω}_{x , k} {c}_{1 , k} + {ω}_{y , k} {c}_{2 , k} + {Ω}_{z , k} {c}_{3 , k} \qquad ( 4 )$$

The correction circuit 323 also predicts a covariance matrix P′k at the time k from a covariance matrix Pₖ of the correction coefficient updated in the update step at the time k−1 in accordance with Expression 5 in the prediction step. A covariance matrix P₀ that is an initial value of the covariance matrix Pₖ is defined as indicated by Expression 6.

$${P}_{k}^{′} = {P}_{k} \qquad ( 5 )$$

$${P}_{0} = ( \begin{matrix}1 & 0 & 0 \\ 0 & 1 & 0 \\ 0 & 0 & 1\end{matrix} ) \qquad ( 6 )$$

Next, in the observation step, the correction circuit 323 makes an expected value Yₖ of the angular speed around the Z-axis into ωₓ, k as indicated in Expression 7.

$${Y}_{k} = {ω}_{z , k} \qquad ( 7 )$$

Also, the correction circuit 323 calculates a variance ρₖ² of the angular speed around the Z-axis, as indicated by Expression 8, in the observation step. In Expression 8, η is calculated as a difference between the expected value Yₖ of the angular speed around the Z-axis and the corrected value Y′ₖ Of Ω_{z}, k predicted in the prediction step at the time K as indicated by Expression 9.

$${ρ}_{k}^{2} = {\{ ( 1 - η ) {ρ}_{k - 1} + η \}}^{2} \qquad ( 8 )$$

$$η = {Y}_{k} - {Y}_{k}^{′} = {Y}_{k} - {X}_{k} {Θ}_{k} \qquad ( 9 )$$

Next, in the update step, the correction circuit 323 calculates a Kalman gain Gₖ₊₁ at a time k+1 from the angular speed matrix Xₖ at the time k, the covariance matrix P′k predicted in the prediction step at the time k, and the variance ρₖ² calculated in the observation step at the time k in accordance with Expression 10.

$${G}_{k + 1} = {P}_{k}^{′} {{X}_{k}^{T} ( {X}_{k} {P}_{k}^{′} {X}_{k}^{T} + {ρ}_{k}^{2} )}^{- 1} \qquad ( 10 )$$

Then, in the update step, the correction circuit 323 updates the correction coefficient matrix θₖ at the time k with a correction coefficient matrix θₖ₊₁ at the time K+1, based on the Kalman gain Gₖ₊₁ at the time k+1, the expected value Yₖ of the angular speed around the Z-axis at the time k, and the angular speed matrix Xₖ at the time k, in accordance with Expression 11. In a manner described above, the correction circuit 323 estimates the correction coefficient matrix θₖ₊₁ at the time k+1 using the Kalman filter.

$$\begin{matrix}{Θ}_{k + 1} = {Θ}_{k} + {G}_{k + 1} ( {Y}_{k} - {X}_{k} {Θ}_{k} ) \\ = ( I - {G}_{k + 1} {X}_{k} ) {Θ}_{k} + {G}_{k + 1} {Y}_{k}\end{matrix} \qquad ( 11 )$$

Also, the correction circuit 323 updates the covariance matrix P′ₖ predicted in the prediction step at the time k with a covariance matrix Pₖ₊₁ at the time k+1, based on the Kalman gain Gₖ₊₁ at the time k+1 and the angular speed matrix Xₖ at the time k, in accordance with Expression 12 in the update step.

$${P}_{k + 1} = ( I - {G}_{k + 1} {X}_{k} ) {P}_{k}^{′} \qquad ( 12 )$$

The correction circuit 323 calculates a corrected value Y′ₖ₊₁ in accordance with Expression 4 described above in the prediction step at the time k+1 using the correction coefficient matrix θₖ₊₁ at the time k+1 with which the correction coefficient matrix θₖ has been updated in the update step at the time k.

By the Kalman filter described above, control is performed such that a difference Yₖ−Y′ₖ=Yₖ−Xₖθₖ between the expected value Yₖ of the angular speed around the Z-axis and the corrected value Y′ₖ of the angular speed around the Z′-axis approaches zero. As a result, an error of the Z′-axis angular speed detection signal SD1GZ′ due to a shift of the Z′-axis with respect to the Z-axis is corrected. In a manner described above, the correction circuit 323 estimates the correction coefficient matrix θₖ using the Kalman filter and generates the Z-axis angular speed detection signal SD1GZ obtained by correcting the Z′-axis angular speed detection signal SD1GZ′ in accordance with a correction expression Y′ₖ=Xₖθₖ that is Expression 4 described above.

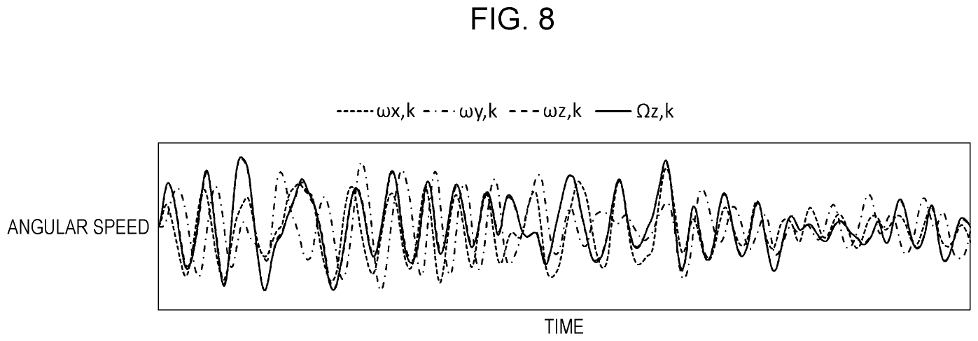

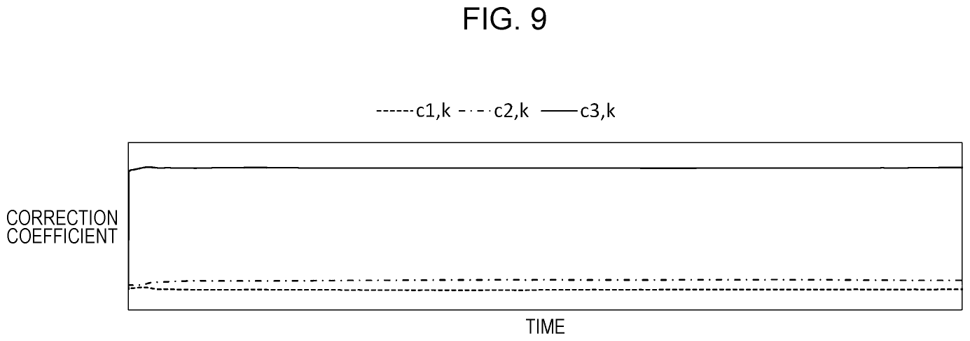

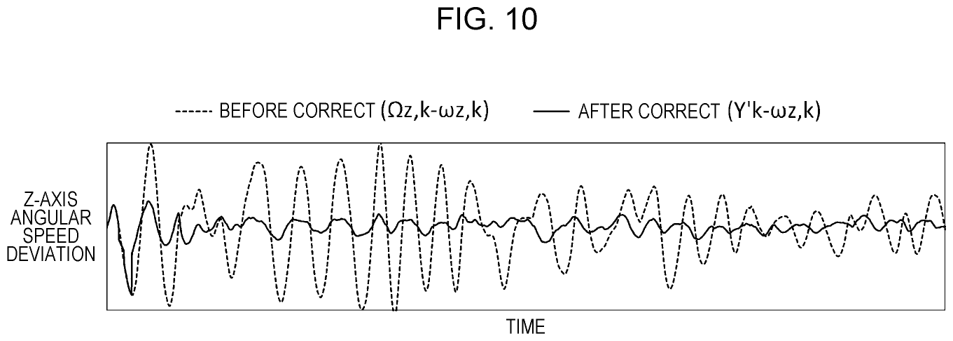

FIG. 8 is a chart illustrating an example of time series data of ωₓ, ₖ, ω_{y}, ₖ, ω_{z}, ₖ, and Ω_{z}, ₖ. In FIG. 9 and FIG. 10, simulation results of correction processing performed by the correction circuit 323 using the time series data of FIG. 8 are illustrated. FIG. 9 is a chart illustrating time series data of alignment correction coefficients c₁, ₖ, c₂, ₖ, and c₃, k that are calculated from ωₓ, ₖ, ω_{y}, ₖ, ω_{z}, ₖ, and Ω_{z}, k of FIG. 8. FIG. 10 is a chart illustrating time series data of a deviation of the Z-axis angular speed before and after correction processing using the correction coefficient matrix θₖ of FIG. 9. As illustrated in FIG. 10, a deviation Y′ₖ−ω_{z}, k of the Z-axis angular speed after correction is remarkably smaller than a deviation Ω_{z}, ₖ−ω_{z}, k of the Z-axis angular speed before correction, and it is understood that correction processing by the correction circuit 323 of this embodiment is very effective.

Note that, in this embodiment, the inertial sensor 20 is an example of the “first axis angular speed sensor” and the X-axis angular speed detection signal SD2GX is an example of the “first angular speed signal.” The inertial sensor 20 is also an example of the “second axis angular speed sensor” and the Y-axis angular speed detection signal SD2GY is an example of the “second angular speed signal.” Moreover, the inertial sensor 20 is also an example of the “third axis angular speed sensor” and the Z-axis angular speed detection signal SD2GZ is an example of the “third angular speed signal.” The angular speed sensor 10 is an example of the “fourth axis angular speed sensor” and the Z′-axis angular speed detection signal SD1GZ′ is an example of the “fourth angular speed signal”.

### 1-5. Effects

As has been described above, in the sensor device 2 of this embodiment, the X-axis angular speed sensor, the Y-axis angular speed sensor, and the Z-axis angular speed sensor are integrally mounted as the inertial sensor 20 on the mounting substrate 4, and therefore, orthogonality of the X-axis, the Y-axis, and the Z-axis is secured. On the other hand, the angular speed sensor 10 is mounted as a separate body from the inertial sensor 20 on the mounting substrate 4, and therefore, misalignment of the angular speed sensor 10 with respect to the inertial sensor 20 can occur. To cope with this, in the sensor device 2 of this embodiment, the processing device 30 can estimate the alignment correction coefficients c₁, ₖ, c₂, ₖ, and c₃, k used for correcting an error of Ω_{z}, k due to a shift of the Z′-axis with respect to the Z-axis, based on ω_{z}, k that is the Z-axis angular speed detection signal SD2GZ and Ω_{z}, k that is the Z′-axis angular speed detection signal SD1GZ′. Furthermore, the processing device 30 can estimate the alignment correction coefficients c₁, ₖ, c₂, ₖ, and c₃, k in consideration of a shift of the Z′-axis with respect to the X-axis and the Y-axis, based on ωₓ, k that is the X-axis angular speed detection signal SD2GX, ω_{y}, k that is the Y-axis angular speed detection signal SD2GY, and Qz, k that is the Z′-axis angular speed detection signal SD1GZ′. Therefore, according to the sensor device 2 of this embodiment, the processing device 30 can estimate the alignment correction coefficients c₁, ₖ, c₂, ₖ, and c₃, k used for correcting an error that occurs to Ω_{z}, k due to misalignment of the angular speed sensor 10 with respect to the inertial sensor 20 with high accuracy. In particular, according to the sensor device 2 of this embodiment, the processing device 30 can efficiently estimate the alignment correction coefficients c₁, ₖ, c₂, ₖ, and c₃, k used for correcting an error of Ω_{z}, k due to a shift of the Z′-axis with respect to the Z-axis by the Kalman filter arithmetic operation in which ω_{z}, k is a target value of Ω_{z}, k. Thus, the processing device 30 can correct Ω_{z}, k with high accuracy using the alignment correction coefficients c₁, ₖ, c₂, ₖ, and c₃, ₖ.

Moreover, in the sensor device 2 of this embodiment, the processing device 30 can estimate the alignment correction coefficients c₁, ₖ, c₂, ₖ, and c₃, k at real time to correct Ω_{z}, k. Therefore, an adjustment work that is performed by a manufacturer of the sensor device 2 and in which the Z′-axis is made to accurately match the Z-axis is unnecessary, and the processing device 30 can correct Ω_{z}, k with high accuracy even when a shift amount between the Z′-axis and the Z-axis is changed due to a secular change.

### 2. Modified Examples

The present disclosure is not limited to the embodiment described above and various modifications are possible within the gist of the present disclosure.

For example, in the embodiment described above, the sensor device 2 includes the angular speed sensor 10 that is a Z′-axis angular speed sensor and the inertial sensor 20 that functions as an X-axis angular speed sensor, a Y-axis angular speed sensor, a Z-axis angular speed sensor, an X-axis acceleration sensor, a Y-axis acceleration sensor, and a Z-axis acceleration sensor, but may include the X-axis angular speed sensor, the Y-axis angular speed sensor, and the Z-axis angular speed sensor, instead of the inertial sensor 20. As another option, for example, the sensor device 2 may include the inertial sensor 20 that functions as an X′-axis angular speed sensor that detects an angular speed around an x′-axis that corresponds to the X-axis, a Y′-axis angular speed sensor that detects an angular speed around a Y′-axis that corresponds to the Y-axis, a Z′-axis angular speed sensor that detects an angular speed around the Z′-axis that corresponds to the Z-axis, the X-axis angular speed sensor, the Y-axis angular speed sensor, the Z-axis angular speed sensor, an X-axis acceleration sensor, a Y-axis acceleration sensor, and a Z-axis acceleration sensor. As still another option, for example, the sensor device 2 may include the X′-axis angular speed sensor, the Y′-axis angular speed sensor, the Z′-axis angular speed sensor, the X-axis angular speed sensor, the Y-axis angular speed sensor, and the Z-axis angular speed sensor.

In the embodiment described above, an example in which the angular speed sensor 10 is a crystal sensor with relatively high detection accuracy and the inertial sensor 20 is a relatively inexpensive silicon MEMS sensor has been described, but types of the angular speed sensor 10 and the inertial sensor 20 are not limited thereto. For example, the angular speed sensor 10 may be an FOG sensor with relatively high detection accuracy and the inertial sensor 20 may be a relatively inexpensive silicon MEMS sensor. FOG is an abbreviation for Fiber Optic Gyroscope.

The embodiment and the modified embodiment that have been described above are merely examples and the present disclosure is not limited thereto. For example, each embodiment and each modified example can be combined as appropriate.

The present disclosure includes a substantially same configuration as a configuration described in the above-described embodiment, that is, for example, a configuration whose function, method, and result are the same as those of the above-described embodiment or a configuration whose object and effects are the same as those of the above-described embodiment. The present disclosure includes a configuration in which a nonessential portion of the configuration described in the above-described embodiment is replaced. The present disclosure includes a configuration that has the same effects as those of the configuration described in the above-described embodiment or a configuration that can achieve the same object as that of the configuration described in the above-described embodiment. Moreover, the present disclosure includes a configuration obtained by adding a known technology to the configuration described in the above-described embodiment.

The following contents are derived from the embodiment and the modified example that have been described above.

According to an aspect, a sensor device includes, when it is assumed that three axes that are orthogonal to each other are a first axis, a second axis, and a third axis, a first axis angular speed sensor that detects an angular speed around the first axis and outputs a first angular speed signal, a second axis angular speed sensor that detects an angular speed around the second axis and outputs a second angular speed signal, a third axis angular speed sensor that detects an angular speed around the third axis and outputs a third angular speed signal, a fourth axis angular speed sensor that detects an angular speed around a fourth axis that corresponds to the third axis and outputs a fourth angular speed signal, and a correction circuit that estimates a correction coefficient used for correcting an error of the fourth angular speed signal due to a shift of the fourth axis with respect to the third axis, based on the first angular speed signal, the second angular speed signal, the third angular speed signal, and the fourth angular speed signal.

In the sensor device, the correction coefficient used for correcting an error of the fourth angular speed signal due to a shift of the fourth axis with respect to the third axis can be estimated based on the third angular speed signal and the fourth angular speed signal. Furthermore, in the sensor device, the correction coefficient also in consideration of a shift of the fourth axis with respect to each of the first axis and the second axis can be estimated based on the first angular speed signal, the second angular speed signal, and the fourth angular speed signal. Therefore, in accordance with the sensor device, the correction coefficient used for correcting an error that occurs to the fourth angular speed signal due to misalignment of the fourth axis angular speed sensor with respect to the first axis angular speed sensor, the second axis angular speed sensor, and the third axis angular speed sensor can be estimated with high accuracy.

According to another aspect, in the sensor device, the correction circuit may estimate the correction coefficient by a Kalman filter arithmetic operation where the third angular speed signal is a target value of the fourth angular speed signal.

According to the sensor device, the correction coefficient used for correcting the error of the fourth angular speed signal due to a shift of the fourth axis with respect to the third axis can be efficiently estimated by the Kalman filter arithmetic operation where the third angular speed signal is the target value of the fourth angular speed signal.

According to another aspect, in the sensor device, when the first angular speed signal is ωₓ, ₖ, the second angular speed signal is ω_{y}, ₖ, the fourth angular speed signal is Ω_{z}, ₖ, an angular speed matrix Xₖ=(ωₓ, ₖ, ω_{y}, ₖ, Ω_{z}, ₖ) holds, the correction coefficient is c₁, ₖ, c₂, ₖ, and c₃, ₖ, and a correction coefficient matrix θₖ=(c₁, ₖ, c₂, ₖ, c₃, ₖ)^{T} holds, the correction circuit may correct the fourth angular speed signal in accordance with a correction expression Y′ₖ=Xₖθₖ.

According to the sensor device, the correction coefficient in consideration a shift of the fourth axis with respect to each of the first axis, the second axis, and the third axis can be estimated to correct the error of the fourth angular speed signal with high accuracy using the correction coefficient.

According to another aspect, in the sensor device, the first axis angular speed sensor, the second axis angular speed sensor, and the third axis angular speed sensor may be integrally mounted on a mounting substrate, and the fourth axis angular speed sensor may be mounted as a separate body from the first axis angular speed sensor, the second axis angular speed sensor, and the third axis angular speed sensor on the mounting substrate.

In the sensor device, the first axis angular speed sensor, the second axis angular speed sensor, and the third axis angular speed sensor are integrally mounted on the mounting substrate, and therefore, orthogonality of the first axis, the second axis, and the third axis is secured. On the other hand, the fourth axis angular speed sensor is mounted as a separate body from the first axis angular speed sensor, the second axis angular speed sensor, and the third axis angular speed sensor on the mounting substrate. Therefore, according to the sensor device, although misalignment of the fourth axis angular speed sensor with respect to the first axis angular speed sensor, the second axis angular speed sensor, and the third axis angular speed sensor can occur, the correction coefficient used for correcting an error that occurs to the fourth angular speed signal due to the misalignment can be estimated with high accuracy.

According to another aspect, in the sensor device, the first axis angular speed sensor, the second axis angular speed sensor, and the third axis angular speed sensor may be mounted on a first surface of the mounting substrate, and the fourth axis angular speed sensor may be mounted on a second surface of the mounting substrate that is in a front and back relationship with the first surface.

According to the sensor device, a size of the mounting substrate can be reduced, so that area saving can be realized.

According to another aspect, in the sensor device, when a bias error of the third angular speed signal is Bz [deg/sec] and a bias error of the fourth angular speed signal is Bz′ [deg/sec], Bz′<Bz may hold.

According to the sensor device, the bias error of the fourth angular speed signal is relatively small, and therefore, an error of an angle around the fourth axis obtained by integrating the fourth angular speed signal can be reduced.

What is claimed is:

1. A sensor device comprising:
when it is assumed that three axes that are orthogonal to each other are a first axis, a second axis, and a third axis,
a first axis angular speed sensor that detects an angular speed around the first axis and outputs a first angular speed signal;
a second axis angular speed sensor that detects an angular speed around the second axis and outputs a second angular speed signal;
a third axis angular speed sensor that detects an angular speed around the third axis and outputs a third angular speed signal;
a fourth axis angular speed sensor that detects an angular speed around a fourth axis that corresponds to the third axis and outputs a fourth angular speed signal; and
a correction circuit that estimates a correction coefficient used for correcting an error of the fourth angular speed signal due to a shift of the fourth axis with respect to the third axis, based on the first angular speed signal, the second angular speed signal, the third angular speed signal, and the fourth angular speed signal.

2. The sensor device according to claim 1, wherein
the correction circuit estimates the correction coefficient by a Kalman filter arithmetic operation where the third angular speed signal is a target value of the fourth angular speed signal.

3. The sensor device according to claim 2, wherein
when the first angular speed signal is ωₓ, ₖ, the second angular speed signal is ω_{y}, ₖ, the fourth angular speed signal is Ω_{z}, ₖ, an angular speed matrix Xₖ=(ωₓ, ₖ, ω_{y}, ₖ, Ω_{z}, ₖ) holds, the correction coefficient is c₁, ₖ, c₂, ₖ, and c₃, ₖ, and a correction coefficient matrix θₖ=(c₁, ₖ, c₂, ₖ, c₃, ₖ)^{T} holds, the correction circuit corrects the fourth angular speed signal in accordance with a correction expression Y′ₖ=Xₖθₖ.

4. The sensor device according to claim 1, wherein
the first axis angular speed sensor, the second axis angular speed sensor, and the third axis angular speed sensor are integrally mounted on a mounting substrate, and
the fourth axis angular speed sensor is mounted as a separate body from the first axis angular speed sensor, the second axis angular speed sensor, and the third axis angular speed sensor on the mounting substrate.

5. The sensor device according to claim 4, wherein
the first axis angular speed sensor, the second axis angular speed sensor, and the third axis angular speed sensor are mounted on a first surface of the mounting substrate, and
the fourth axis angular speed sensor is mounted on a second surface of the mounting substrate that is in a front and back relationship with the first surface.

6. The sensor device according to claim 1, wherein
when a bias error of the third angular speed signal is Bz [deg/sec] and a bias error of the fourth angular speed signal is Bz′ [deg/sec], Bz′<Bz holds.
